(19) United States
(12) Patent Application Publication
(10) Pub. No.: US 2007/0009185 A1
(43) Pub. Date: Jan. 11, 2007

(54) Handle structure for a body bag

(75) Inventor: Chin-Chang Lee, Yuan Li Chen (TW)

Correspondence Address: SWEPO CO., LTD., NO. 68-17, HSING LUNG RD., YUAN LI CHIEN (R.O.C.), 358, TW

(73) Assignee: Swepo Co., Ltd.

(21) Appl. No.: 11/481,382

(22) Filed: Jul. 6, 2006

(30) Foreign Application Priority Data
Jul. 11, 2005 (TW) 094211766

(51) Int. Cl. B65D 33/06; A45F 3/14; A61G 1/00

(52) U.S. Cl. 383/16; 383/18; 224/157

(57) ABSTRACT

The present invention relates to a handle structure for a body bag. The body bag comprises a bag, a zipper, a plurality of stopping plates, and a plurality of handles. The feature of the present invention is that both sides of the handles have an inward folding parts thereof, forming an arc-strengthened support. The horizontal supporting belt is formed in the middle of the handle in one-piece. The horizontal supporting belt having a plurality of vertical supporting belts which are inwardly folded with handle in an arc shape under thermocompression bonding for ease of carrying. Further, the handle and the bag are also are joined together by thermocompression bonding, and the vertical supporting belts and horizontal supporting belts of the handle are joined with the bag by thermocompression bonding which is easy to carry and has a high tensile strength.

### BACKGROUND OF THE INVENTION

1. Field of the Invention

This invention relates to an improved handle structure for a human body bag. More particularly, it is applied to the package used to carry a human body.

2. The Prior Arts

Conventionally, a handle structure for a body bag can be shown in FIG. 6. The upper fabric forms an opening (11) as well as a bag cover (12), and further uses a stitched seam (70) with a zipper (20). The surrounding area of the upper and the lower fabrics use stitched seam (70) to form a bag (10). Moreover, the bag (10) uses the stitched seam (70) or heat stick (80) to join with the woven handle (64). However, although a human body can be transported, there are still many shortcomings, such as:
1. The woven belt used for the handle, and the stitched seam or heat stick is used on the bag. Therefore, leakage can occur during usage.
2. The woven belt used for the handle, and the stitched seam or heat stick is used on the bag. When the operator holds the woven belt during transportation, the force is concentrated on the woven belt part inside the bag. Therefore, the body bag is easily broken.
3. If fabric is seamed to the handle and fabric is further seamed to the bag, the cost will increase based on this repeated and complicated use.

The present invention is improved to overcome the above-mentioned shortcomings, such as uneasy transportation, bag leakage, and complicated and heavy structure of the prior art. Therefore, a handle structure for a body bag is provided in the present invention.

### SUMMARY OF THE INVENTION

In order to solve the shortcomings of the prior art, the primary object of the present invention is to provide an efficient, light and rigid handle structure for a body bag. Therefore, the laden body bag can be easily carried and does not leak or break easily.

### BRIEF DESCRIPTION OF THE DRAWINGS

FIG. 1 is a 3-D assembly diagram of the present invention;

FIG. 2 is an exploded view for a handle in the present invention;

FIG. 3 shows a plurality of handle structures used in combination in an embodiment of the present invention;

FIG. 4 shows a handle structure under use in an embodiment of the present invention;

FIG. 5 shows a preferred embodiment of the present invention; and

FIG. 6 is a handle structure of the prior art.

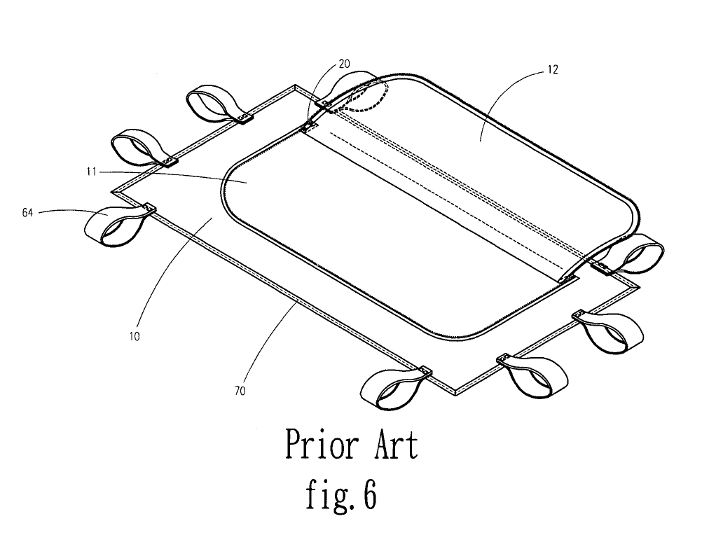

### DETAILED DESCRIPTION OF THE PREFERRED EMBODIMENT

Other advantages, objects, technical features, and effects of the present invention can be understood by following the detailed descriptions of the preferred embodiments in conjunction with the drawings.

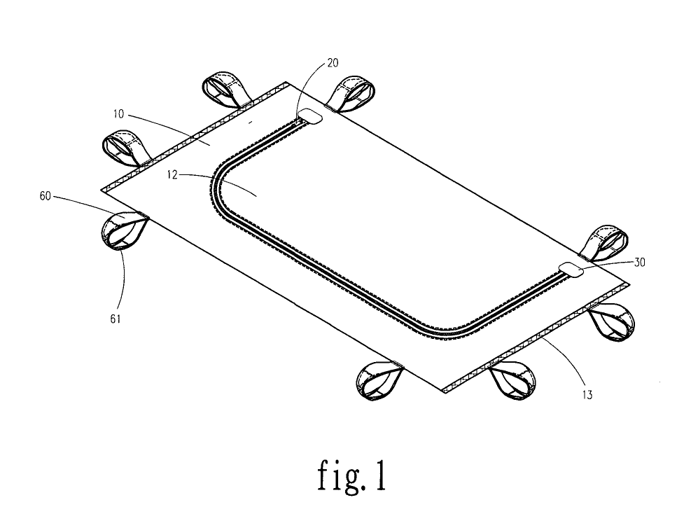

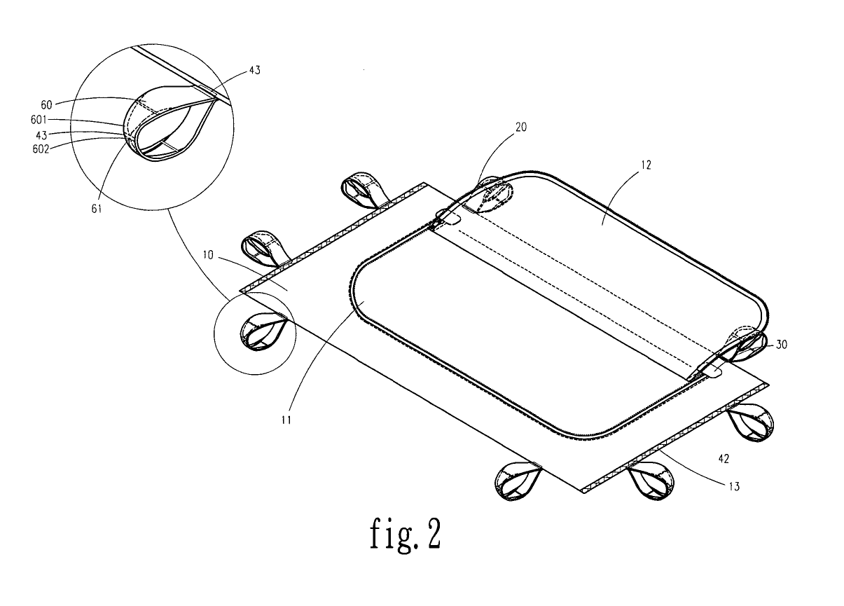

Please refer to FIG. 1 to FIG. 3. The figures are 3-D assembly diagrams showing a handle structure for a human body bag in the present invention. The handle structure of the present invention comprises:

a bag (10) having an opening (11) and a bag cover (12);

a bag zipper (20);

a plurality of stopping plates (30); and

a plurality of handles (60).

Handles (60) have holding parts (61). Both sides of said holding parts (61) have an inward folding part (601). The inward folding part (601) forms an arc-strengthened support (602) thereof with the distal ends being wider than the middle. The narrower part is more comfortable to carry. A horizontal supporting belt (62) is formed in the middle of handle (60) from one piece, and is attached to a plurality of vertical supporting belts (63).

By referring to the above structure, a handle structure for a human body bag is implemented in the present invention.

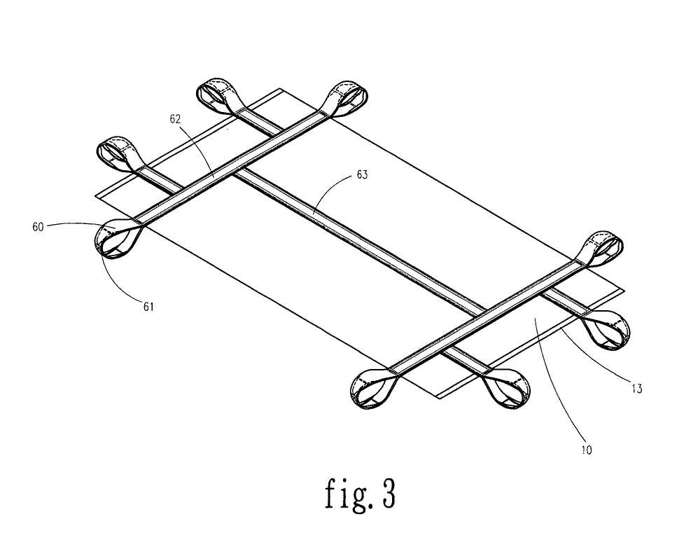

Please refer to FIG. 3, which shows a plurality of handle structures used in combination in an embodiment of the present invention. The underside of body bag (10) is bonded to a handle (60). Both sides of holding part (61) in handle (60) have inward folding parts (601). Inward folding part (601) forms arc-strengthened support (602) by thermocompression bonding (43). The width gradually narrows, and the middle is the narrowest for holding. Horizontal supporting belt (62) has a plurality of vertical supporting belts (63). Inward folding part (601) and handle (60) forms an arc shape under thermocompression bonding (43). Further, handle (60) and bag (10) are joined together by thermocompression bonding (43), and vertical supporting belts (62) and horizontal supporting belts (63) of handle (60) join to bag (10) by thermocompression bonding (43).

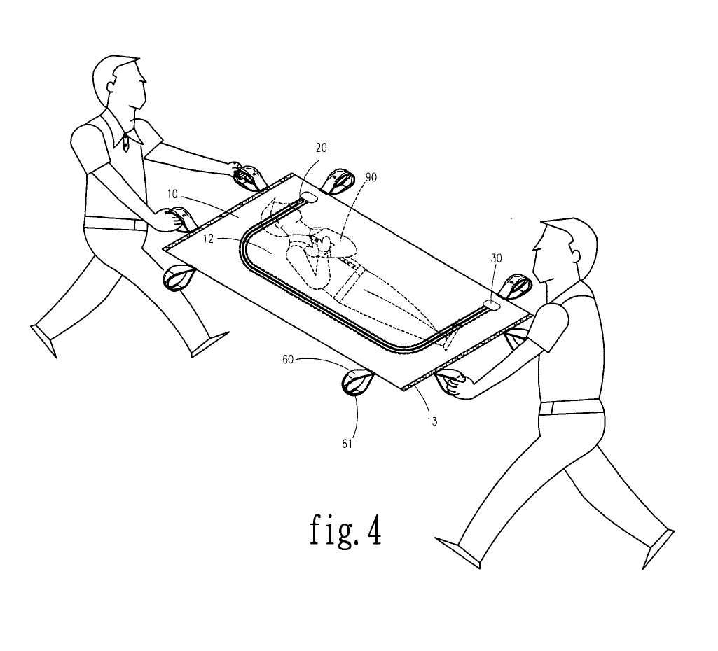

Now referring to FIG. 4, the operation of the present invention is easy and requires grasping holding part (61) of handle (60) for carrying bag (10) containing human body (90). Moreover, it has a plurality of horizontal and vertical supporting belts (62) and (63). It does not cause difficulties or bag leakage during transporting of human body (90).

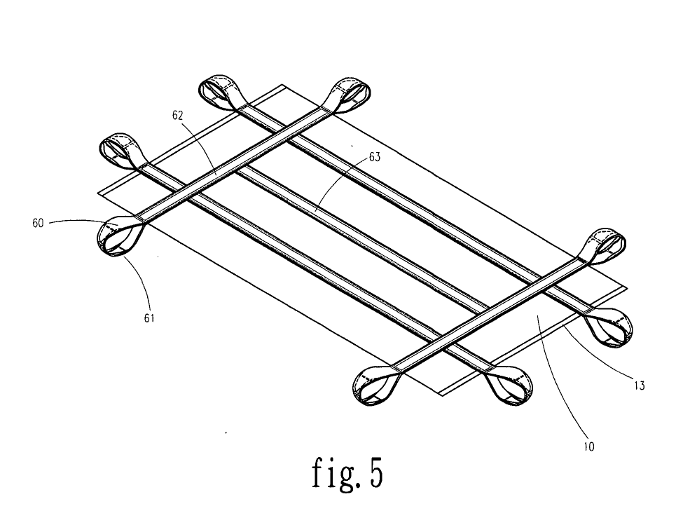

FIG. 5 is the preferred embodiment of the invention shown in FIG. 1 to FIG. 3 wherein handles (60) having horizontal supporting belts (62) have a plurality of vertical supporting belts (63) for increased strength.

The advantages of the present invention are the following:

1. Both sides of the holding part in the handle each have an inward folding part. The inward folding part is an arc shape, and the end of the arc shape uses is joined using thermocompression bonding forming a handle. The handle, therefore, has a higher tensile strength.
2. The holding part of the handle becomes narrower from its distal ends towards the middle. Although the middle is narrower, the strength is not affected since both sides are folded under thermocompression bonding.
3. The handle not only has a horizontal supporting belt but also has vertical supporting belt. The horizontal and vertical supporting belts are joined to the bag with thermocompression bonding. Therefore, the force is uniformly distributed in the horizontal supporting belt, vertical supporting belt, and handle while transporting the laden body bag. In other words, the load is spread to prevent broken handles and or damaged bags.
4. Since the handle and bag are joined with thermocompression bonding, the materials of the handle and the bag are light and efficient.
   The present invention was not disclosed or used before and meets the patent requirements; thus it should be granted a patent.
   It is appreciated that the above description is preferred embodiments of the present invention, not intending to limit the present invention. Any changes made to the concept of the present invention without departing from the spirit of the present invention and other variations, modifications, applications, and equivalents, such as altering the formation or arrangement models are covered by the claims of the present invention.

What is claimed is:

1. A handle structure for a body bag, comprising a bag and a plurality of handles, characterized in that both sides of said handles have an inward folding part, and the middle of said inward part forms an arc-strengthened support.

2. The handle structure for a body bag in claim 1, wherein the horizontal supporting belt formed in the middle of said handle is one-piece, the horizontal supporting belt is supported by a plurality of vertical supporting belts, wherein said horizontal supporting belt having a handle which is inwardly folded by thermocompression bonding is also joined to the bag by thermocompression bonding.
